(19) United States
(12) Patent Application Publication
(10) Pub. No.: US 2019/0061441 A1
(43) Pub. Date: Feb. 28, 2019

(54) DEVICE FOR CONTROLLING THE PRESSURE OF A BICYCLE TIRE AND BICYCLE WHEEL COMPRISING SAID DEVICE

(71) Applicants: Pascal Boutru, Le Chesnay (FR); Stéphane Gonnet, Orleans (FR); Joël Balez, Amilly (FR); Clovis Le Goff, Levallois Perret (FR); Jean-Pierre Benoist, Sandillon (FR)

(72) Inventors: Pascal Boutru, Le Chesnay (FR); Stéphane Gonnet, Orleans (FR); Joël Balez, Amilly (FR); Clovis Le Goff, Levallois Perret (FR); Jean-Pierre Benoist, Sandillon (FR)

(73) Assignee: HUTCHINSON, Paris (FR)

(21) Appl. No.: 16/117,765

(22) Filed: Aug. 30, 2018

(30) Foreign Application Priority Data
Aug. 30, 2017 (FR) 1758016

(51) Int. Cl. B60C 23/00; B60B 21/00

(52) U.S. Cl. CPC B60C 23/004; B60C 2200/12; B60B 21/00

(57) ABSTRACT

Embodiments of the disclosure relate to devices for controlling the pressure of bicycle tire. The devices generally include a casing configured to be housed inside a bicycle wheel and in which are arranged: a measurement unit comprising at least one sensor capable of measuring a pressure of the bicycle tire and producing a signal indicative of the value of the pressure, a transmission unit electrically connected to the measurement unit and capable of transmitting the signal to an external display, and a battery. The casing includes an opening passing through the casing, from an upper face to a lower face, the opening presenting at least one part flaring from its lower face towards the upper face, so as to define a slope adapted to fit a flared support, corresponding to a foot of the valve of the wheel.

### PRIORITY CLAIM

This application claims priority under 35 U.S.C. § 119 to French Patent Application No. 1758016, filed Aug. 30, 2017, which is herein incorporated by reference in its entirety.

### FIELD OF THE DISCLOSURE

Embodiments of the disclosure relate to a device for controlling the pressure of a bicycle tire and to a bicycle wheel comprising the device.

### BACKGROUND

Tire pressure is an important variable for the performance of a cyclist. Indeed, a loss of pressure may cause additional efforts on the part of the cyclist and his performance is at risk of being lowered. This is particularly true for cyclists who participate in races. Furthermore, extremely low air pressure can lead to risky situations which can, in the worst case, cause a fall of the cyclist.

There are several types of devices for measuring and controlling the pressure of bicycle tires.

A first type of device, external to the tire, presents itself in the form of a valve head that is screwed onto the valve of the bicycle wheel and communicates the pressure measurement to a connected device through a wireless transmitter. Such a device enables the control of the value of the pressure of the tire, can easily be put in place on the valve and is compatible both with wheels featuring an air chamber and with wheels without an air chamber of the “tubeless”-type. However, this device presents several disadvantages. A first disadvantage resides in the unsightly aspect of the device, which is visible on the outside of the wheel. Furthermore, owing to its location outside the tire, this device risks being damaged, in particular in the case of use with a mountain bike. Moreover, the device risks being stolen if the bicycle is left unattended.

Another type of device for measuring and controlling the pressure of bicycle tires includes in a patch stuck to the air chamber of the tire. The device is then maintained under pressure, inside the tire, between the air chamber and the rim of the wheel. Such a device is only compatible with wheels that comprise air chambers and not with “tubeless” types of wheels. Furthermore, such a device is secured to the air chamber, and it is therefore impossible to change the air chamber without changing all or part of the device for controlling the pressure. Moreover, the fixing system of such a device is not reliable, and the device can move and thus affect the pressure measurement.

There are also pressure control devices that are directly integrated in the air chamber or in the valve of the air chamber. Once again, such a device cannot be reused with another air chamber and is not compatible with “tubeless” wheels.

### SUMMARY

Embodiments of the present disclosure aim to remedy, at least partially, the abovementioned disadvantages or others by proposing a device for controlling the pressure of a bicycle tire that is not visible outside the tire, and that presents a reliable fixing system that is easy to install and replace by the user.

Some embodiments of the present disclosure also relate to a pressure control device for a bicycle tire that is compatible with all types of bicycle tires, regardless of whether they comprise an air chamber or not.

In one aspect, embodiments of the present disclosure relate to a device for controlling the pressure of a tire mounted on a bicycle wheel, the device comprising a casing configured to be housed inside the wheel and in which are arranged:
a measurement unit comprising at least one sensor capable of measuring a pressure (p) of the bicycle tire and producing a signal (s) indicative of the value of the pressure (p),
a transmission unit electrically connected to the measurement unit and capable of transmitting the signal (s) to a display means that is external to the device,
a battery capable of electrically supplying the different elements of the device,
an opening passing through the casing, from an upper face of the casing to a lower face of the casing, the lower face being opposite to the upper face, the opening presenting at least one part flaring from its lower face towards the upper face, for example conical, so as to define a slope adapted to fit a flared support, for example conical, corresponding to a foot of the valve of the wheel.

Advantageously, such a device is not visible from the exterior of the wheel, presents a reliable attachment system, and is easily set up and replaced by the user.

In another aspect, embodiments of the disclosure can also comprise any one of the following characteristics, taken individually or in any technically possible combination:
the device comprises at least one adaptor housed in the opening and configured so as to adjust the diameter and the slope of the opening to another type of valve,
the opening separates the device in two parts, a first part accommodating the measurement unit and a second part accommodating the transmission unit and the battery,
the device presents a U-shaped section,
the measurement unit comprises a first pressure sensor capable of measuring the pressure of a bicycle tire fitted with an air chamber and a second pressure sensor capable of measuring the pressure of a tubeless bicycle tire,
the first pressure sensor is a piezoelectric-type sensor and the second pressure sensor is a sensor comprising a ceramic cell,
the first pressure sensor is located on the surface of the casing, on the upper face of the casing and is covered by a liquid-tight protective membrane,
the second pressure sensor is located inside the casing and is in communication with the exterior of the casing by means of a channel, the channel opening onto the upper face of the casing and comprising a protective gel allowing the passage of air and preventing the passage of liquids.

Embodiments of the disclosure also relate to a bicycle wheel comprising a rim and a device according to the disclosure, the casing of the device being configured so as to fit in the inner volume of the rim.

Embodiments of the disclosure can also present a radius of curvature that is less than the radius of curvature of the wheel rim.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 shows a bicycle wheel comprising an example of a device for measuring the pressure of the tire according to the disclosure;

FIG. 2 is a magnified and cross-section view of FIG. 1 at the level of the device according to the disclosure;

FIG. 3 is another view of the device according to the disclosure inside the tire of the bicycle wheel;

FIG. 4 is a view of the device, alone, in a perspective view;

FIG. 5 is another perspective view, partially exploded, of the device according to the disclosure shown in FIG. 4;

FIG. 6 is a transversal cross-section view of the device shown in FIG. 4; and

FIG. 7 is a transversal cross-section view of the device according to another embodiment of the disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

In the following description, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may also reference quantities and numbers. Unless specifically stated, such quantities and numbers are not to be considered restrictive, but exemplary of the possible quantities or numbers associated with the present application. Also in this regard, the present application may use the term “plurality” to reference a quantity or number.

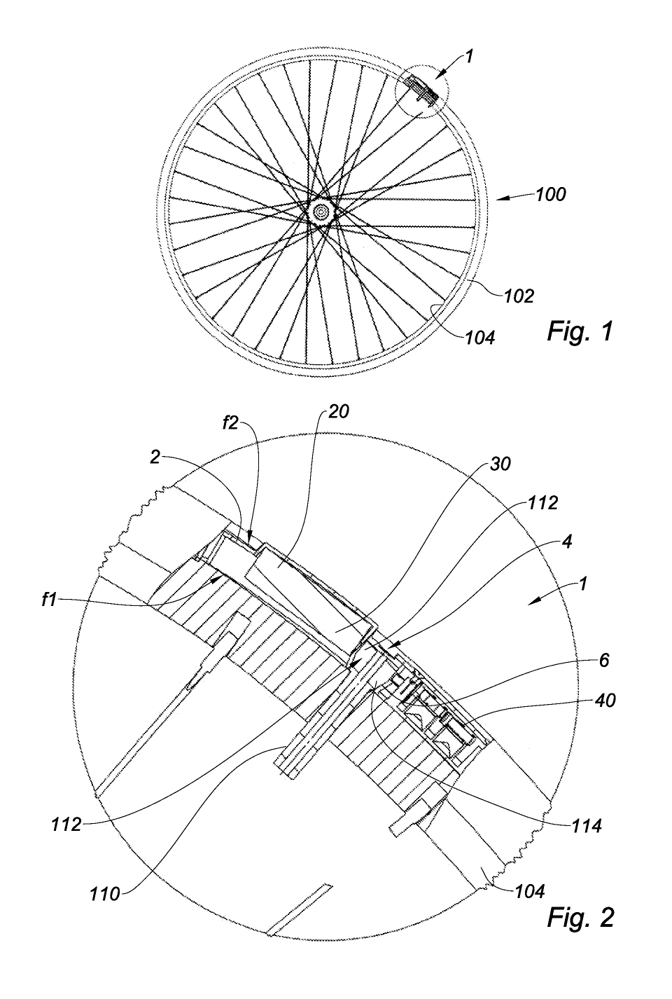

FIG. 1 shows one non-limiting embodiment that comprises a device 1 for controlling the pressure of a bicycle tire 102 comprising a casing 2 configured so as to be housed in a wheel 100. Advantageously, the casing 2 is configured so as to be housed against the inner wall of a rim 104 of the wheel 100. Thus, once installed, the device 1 is covered by the tire and is not visible from the outside and does not risk being damaged or stolen.

As shown in further detail in FIG. 2, the non-limiting device 1 according to the disclosure is advantageously put in place at the level of a valve 110 for inflating the tire.

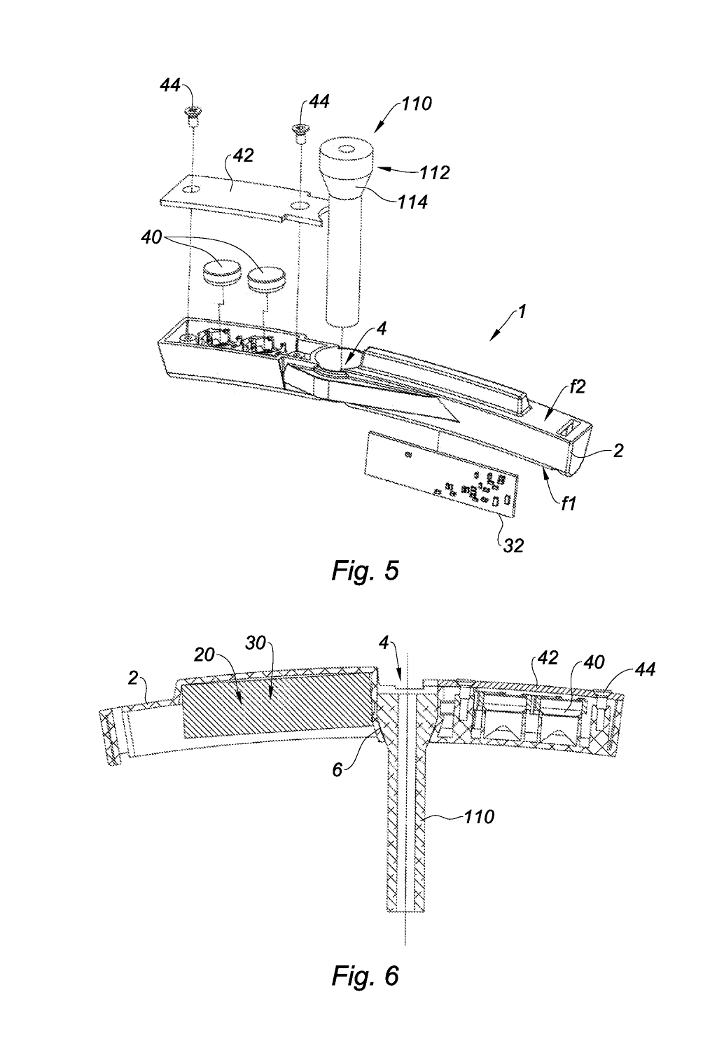

The casing 2 features a measurement unit 20 comprising at least one sensor capable of measuring a pressure (p) of the bicycle tire 102 and producing a signal (s) indicative of the value of the pressure (p). This measurement unit 20 is schematically shown in FIGS. 2 and 6.

The casing 2 also comprises a transmission unit 30 electrically connected to the measurement unit 20 and configured to transmit the signal(s) to a display means (e.g., an LCD display screen) that is visible to the cyclist. The transmission unit 30 can, in particular, feature for this purpose an electronic card 32, as well as wireless communication means (e.g., a transceiver, a transmitter, or a radio device) with the display means. This transmission unit 30 is schematically shown in FIGS. 2 and 6.

The casing 2 further comprises a battery 40 capable of electrically supplying the different elements of the device 1.

The casing 2 can be made of any material that is suitable for such devices, such as thermoplastic materials. Advantageously, the casing 2 is sealed with respect to liquids but not to gases.

The casing 2 features a lower face (f1) and an upper face (f2) opposite to the upper face. The lower face (f1) is located against the bottom of a rim 104 of the wheel 100.

The casing 2 is configured to be reversibly fixed at the level of the foot 112 of the valve 110. Thus, the device 1 can be adapted to an existing wheel 100 and removed if necessary.

The casing 2 comprises an opening 4 passing through the casing 2 from its upper face (f2) to its lower face (f1) and intended to receive the valve 110. Thus, when the device 1 is in place in the wheel 100, the valve 110 for inflating the tire 102 is inserted into the opening 4 and opens out of the tire.

The opening 4 presents at least one part flaring from the lower face (f1) towards the upper face (f2) so as to define a slope 6. In the following description, contemplates a case wherein the flared section of the opening 4 is conical.

When the valve 110 is fixed to the rim 104, for example by means of a valve nut outside of the rim, the device 1 is also fixed to the rim 104. Once the device 1 in place in the wheel 100 and the valve 110 is fixed, the pressure of the tire 102 can be adjusted by using the valve 110, without removing the device 1 of the wheel 100.

As shown in FIG. 5, the valve 110 for inflating the tire 102 features a first part, with a substantially straight section, and a second part, featuring a section with a diameter that is greater than the diameter of the first part. The second part of the valve 110 is called foot 112 of the valve 110. It is this foot 112 which is inserted in the conical opening 4 of the casing 2 when the device 1 is installed in the wheel 100. As can be seen in FIG. 5, the diameter of the foot changes along the foot 112. The part of the foot 112 of the valve 110 where the diameter diminishes is called flared support 114 of the valve 110. In the following description contemplates a case where the flared support 114 is conical and therefore discusses conical support; however, this is just one non-limiting example.

Advantageously, the conical opening 4 separates the device into two parts. A first part is intended to accommodate the measurement unit 20 and the transmission unit 30 and a second part is configured to accommodate the battery 40.

The central position of the conical opening 4 and this arrangement of the different units distribute the weight of the device 1 with respect to the attachment zone located at the level of the conical opening 4. Thus, the device 1 will be less prone to moving when the bicycle is being used.

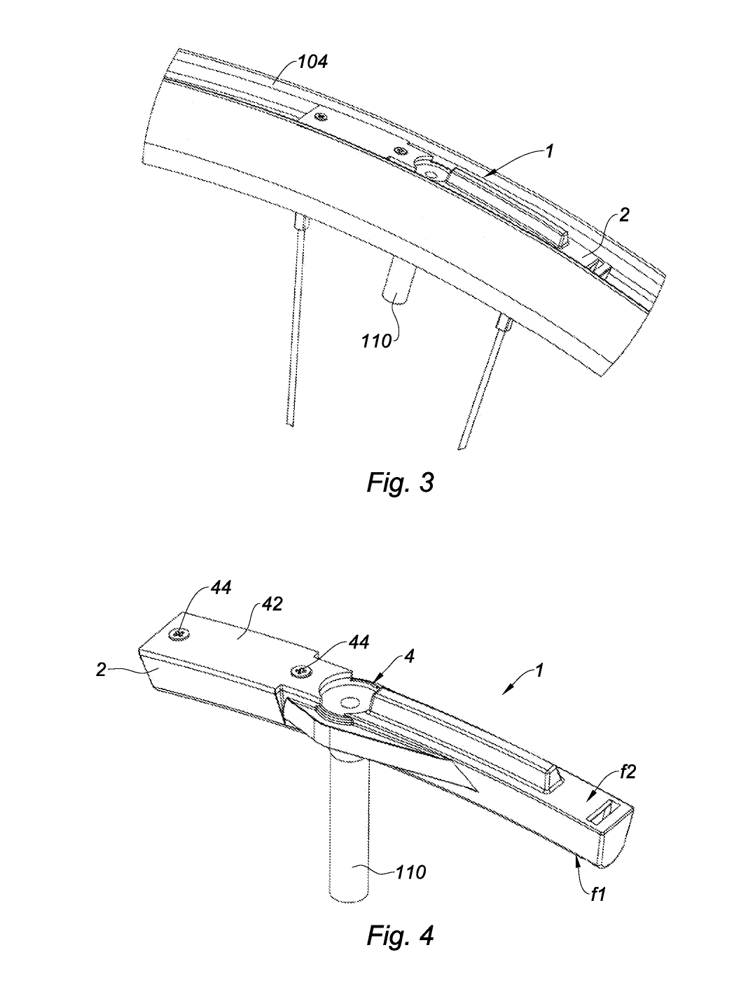

The miniaturization of the device 1 is also a purpose of the present disclosure. Indeed, as shown in FIG. 3, the casing 2 of the device 1 is advantageously configured so as to insert itself inside the inner volume of the tire, delimited by the rim 104 when the device 1 is in place in the wheel 100.

Thus, in the case wherein the tire 102 loses too much pressure, the device 1 is protected by the sides of the rim 104 and is not at risk of being damaged.

The lower face f1 of the device 1 advantageously presents a U-shaped. This particular shape allows the device 1 to fit optimally at the bottom of the rim 104, thereby reducing the volume used by the device 1.

FIGS. 4 to 6 show the device 1 outside the wheel 100. Advantageously, the device 1 can also present side rigidification ribs. As shown in FIG. 5, the battery 40 is accessible through a removable cover 42. The cover can, for example, be fixed by means of screws 44.

Advantageously, the battery 40 may include one or several cells. Therefore, the user can himself replace the battery 40 of the device 1 without resorting to complex operations.

After having replaced the battery 40 of the device 1, the user closes the cover 42 of the battery 40. Advantageously, the casing 2, once closed, is liquid tight.

As shown in FIG. 6, the diameter of the conical opening 4 at the level of the lower face (f1) is smaller than the diameter of the opening at the level of its upper face (f2). The opening 4 thus presents at least one part that flares from the lower face (f1) of the casing 2 towards the upper face (f2) of the casing 2, so as to define a slope 6. This slope 6 is able to fit a conical support 114 that corresponds of the foot 112 of the valve 110 of the wheel 100.

This complementarity shape of the foot 112 of the valve 110 and the conical opening 4 of the device 2 allows a reliable fastening of the device 1 in the wheel 100.

Advantageously, the foot 112 of the valve 110 is made of rubber. In this case, the interaction between the rubber of the foot 112 of the valve 110 and the thermoplastic material of the casing 2 limits vibrations.

There are different types of valves depending on the type of wheel. Not all valves necessarily have the same size or shape. Thus, the conical opening 4 is configured to accommodate a valve 110 of maximum standard size.

Advantageously, the device 1 comprises at least one adaptor 8 housed in the conical opening 4 and configured to adjust the diameter and slope 6 of the conical opening 4 to another type of valve 110. Also advantageously, the device 1 comprises an adaptor 8 for each type of valve 110 available on the market.

Therefore, regardless of the type of valve 110 fitted on the wheel 100, the device 1 presents, via the adaptor 8, a conical opening 4 with a shape complementary to that of the valve 110. The adaptor 8 is not shown in the FIGURES.

Advantageously, the device 1 is slightly curved lengthwise. Thus, as shown in FIG. 6, the device 1 presents a radius of curvature.

Also advantageously, the device 1 presents a radius of curvature that is less important than the radius of curvature of the rim 104. In practice, the radius of curvature is smaller than the radius of curvature of the smallest model of classic rim, for example a 26-inch rim. Thus, regardless of the model of the user's bicycle rim, the device will present a radius of curvature that is smaller than that of the rim.

By presenting a radius of curvature that is smaller than that of the rim 104, the device 1 presents a slight resistance force when placed in the wheel 100. This resistance ensures proper contact between the casing 2 of the device 1 and the bottom of the rim 104, which adds to the reliability of the attachment of the device 1 in the wheel 100.

A device 1, such as described above, is not visible from the exterior of the wheel 100, presenting a simple attachment system that is reliable and can be easily set up and replaced by the user.

Another object of the disclosure is to provide a pressure control device 1 for a bicycle tire 102 that is compatible with all types of bicycle tires, with or without an air chamber.

Indeed, the same pressure sensor is not necessarily compatible with every type of wheel. Depending on the type of wheel being used, the pressure measurement technology is different.

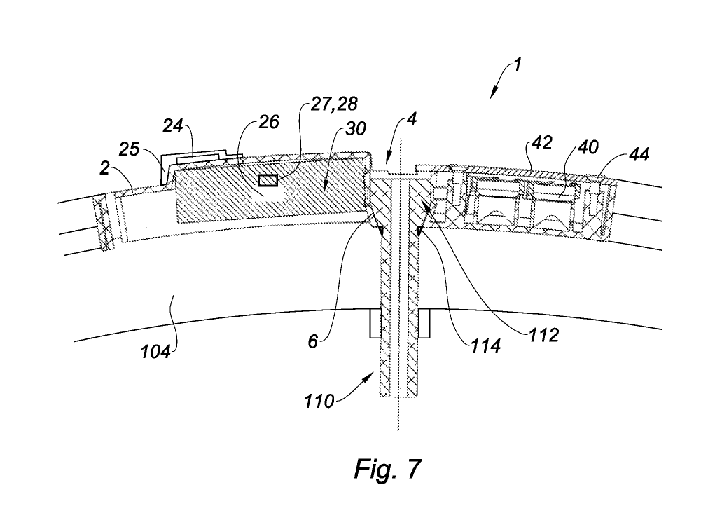

As shown in FIG. 7, according to one non-limiting embodiment of the disclosure, the measurement unit 20 of the device 1 comprises two different pressure sensors. A first pressure sensor 24 is capable of measuring the pressure of a bicycle tire 102 fitted with an air chamber, and a second pressure sensor 26 is capable of measuring the pressure of bicycle tire 102 without air chamber. The presence of two different types of sensor within a single device 1 for controlling the pressure of a bicycle tire 102 makes it possible to extend the use of the device 1 to all types of wheels 100.

The first pressure sensor 24 is a piezoelectric-type sensor and the second pressure sensor 26 is a sensor comprising a ceramic cell.

Advantageously, the first pressure sensor 24 is located on the surface of the casing 2, on the upper face (f2) of the casing 2. As shown in FIGS. 3 to 6, the casing 2 of the device 1 may present a part that protrudes with respect to the upper face (f2). It is advantageously on the surface of this protruding part that the first pressure sensor 24 is positioned.

Thus, when the device 1 is used with a wheel 100 presenting an air chamber, the air chamber bears against the upper face (f2) of the device 1, advantageously against its protruding part, and therefore against the piezoelectric sensor 24. The piezoelectric sensor 24 therefore makes it possible to measure the pressure of the bicycle tire.

Also advantageously, the first sensor 24 is covered with a protective membrane 25 that is liquid-tight. This membrane 25 makes it possible to protect the first sensor 24 from liquids, especially when the device is used in a wheel without air chamber of the type “tubeless”.

Indeed, “tubeless” wheels require the use of a preventive liquid during their installation. When the tire is fitted onto the rim, a liquid is introduced in the inner volume of the tire so as to prevent punctures. The membrane 25 protects the first sensor 24 from such liquids. Otherwise, this liquid can come into contact with the devices for controlling the pressure of the tire and is likely to damage the pressure sensor.

The protective membrane thus makes it possible to use the device 1 in all types of wheels 100.

The second pressure sensor 26 is located inside the casing 2 and is in communication with the outside of the casing via a channel 27 opening at the upper face (f2) of the casing 2.

In some embodiments, the channel 27 features a protective gel 28 that allows the passage of air and prevents the passage of liquids.

In some embodiments, the device can also comprise an accelerometer to activate the device 1 when the wheel 100 is in motion, which enables to save the battery 40 and the lifespan of the device 1.

In some embodiments, the measurement unit 20 can be configured so as to perform a pressure measurement at various frequencies, the measurement frequency being variable depending on the type of bicycle use.

For example, a first measurement frequency might correspond with the mounting of the device on the bicycle wheel. This frequency will be relatively high. A second measurement frequency might correspond with the adjustment of the pressure of the tire 102. A third measurement frequency might correspond with the use of the bicycle. This frequency might be relatively low with respect to the other frequencies.

Another purpose of the disclosure is a bicycle wheel 100 that comprises a rim 104 and the device 1 described above. This wheel 100 is shown in FIG. 1. The casing 2 of the device 1 of the wheel 100 is configured so as to fit in the inner volume of the rim 104 of the wheel 100. Advantageously, the device 1 of the wheel 100 presents a radius of curvature that is less than the radius of curvature of the rim 104 of the wheel 100.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A device for controlling a pressure of a tire mounted on a bicycle wheel, said device comprising:
a casing configured to be housed inside the wheel and in which are arranged;
a measurement unit comprising at least one sensor configured to measure a pressure of said tire and producing a signal indicative of the pressure;
a transmission unit electrically connected to said measurement unit and configured to transmit said signal to a display that is external to the device; and
a battery configured to electrically supply the device,
wherein said casing comprises an opening passing through the casing, from an upper face of the casing to a lower face of the casing, said lower face being opposite to the upper face, said opening presenting at least one part flaring from its lower face towards the upper face, so as to define a slope adapted to fit a flared support, for example conical, corresponding to a foot of a valve of the wheel.

2. The device according to claim 1, wherein the device comprises at least one adaptor housed in the opening and configured so as to adjust a diameter and the slope of said opening to another type of valve.

3. The device according to claim 1, wherein said opening separates the device in two parts, a first part accommodating the measurement unit and a second part accommodating the transmission unit and the battery.

4. The device according to claim 1, wherein the device presents a U-shaped section.

5. The device according to claim 1, wherein the measurement unit comprises a first pressure sensor capable of measuring the pressure of said tire if said tire is fitted with an air chamber, and a second pressure sensor capable of measuring the pressure of said tire if said tire is tubeless.

6. The device according to claim 5, wherein the first pressure sensor is a piezoelectric-type sensor and the second pressure sensor comprises a ceramic cell.

7. The device according to claim 5, wherein the first pressure sensor is located on a surface of the casing, on the upper face of the casing and is covered by a liquid-tight protective membrane.

8. The device according to claim 5, wherein the second pressure sensor is located inside the casing and is in communication with an exterior of the casing by a channel, said channel opening onto the upper face of the casing and comprising a protective gel allowing the passage of air and preventing the passage of liquids.

9. A bicycle wheel comprising a rim and the device according to claim 1, wherein the casing of the device is configured so as to fit in an inner volume of the rim.

10. The bicycle wheel according to the claim 9, wherein the device presents a radius of curvature that is less than the radius of curvature of the rim of the wheel.
